(19) United States
(12) Patent Application Publication
(10) Pub. No.: US 2024/0426709 A1
(43) Pub. Date: Dec. 26, 2024

(54) WHEEL DETACHMENT MONITORING AND DETECTION DEVICE

(71) Applicant: CUB ELECPARTS INC., Changhua County (TW)

(72) Inventors: Tsan-Nung Wang, Changhua County (TW); Ming-Li Chou, Changhua County (TW)

(73) Assignee: CUB ELECPARTS INC., Changhua County (TW)

(21) Appl. No.: 18/743,668

(22) Filed: Jun. 14, 2024

Related U.S. Application Data
(60) Provisional application No. 63/522,263, filed on Jun. 21, 2023.

(51) Int. Cl. G01M 17/013; G01K 3/00; G08B 21/18

(52) U.S. Cl. CPC G01M 17/013; G01K 3/005; G08B 21/18

(57) ABSTRACT

A wheel detachment monitoring and detection device is to be installed on a vehicle wheel. The wheel detachment monitoring and detection device includes a washer, a housing, a detachment detection module, and a power source. The washer defines a through hole for a fastening member to pass and fix the washer, and has an engaging portion partially covered by the fastening member. The housing gets engaged with the engaging portion and accommodates the detachment detection module. The detachment detection module has a pressure sensing portion that is pressed by the fastening member to press against the vehicle wheel, and detects a pressing force acting thereon. When the pressure sensing portion detects that the pressing force disappears, the detachment detection module sends out a warning signal. The wheel detachment monitoring and detection device ensures attachment of the vehicle wheel by monitoring looseness of the fastening member.

### BACKGROUND OF THE INVENTION

### 1. Technical Field

The present invention relates to a detection device, and more particularly to a wheel detachment monitoring and detection device.

### 2. Description of Related Art

Detachment of vehicle wheels during driving is heard from time to time, and can put the cars affected thereby in great danger. Furthermore, the detached wheels, when left in the lane, can seriously threaten safety of nearby cars and road-users. A wheel of a car comprises a wheel rim attached to the hub of the car and a tire mounted around the wheel rim. The wheel rim is provided with plural through holes for bolts extended from the hub to pass therethrough and to be engaged with plural nuts, so that the wheel rim can be fixed to the hub.

Commercial vehicles and heavy-duty vehicles are particularly subject to wear and tear of tires due to their frequent use and heavy loads, and thus require regular replacement of tires. Therefore, for these vehicles, a fastening structure (i.e., the foregoing bolts and nuts) used to fix the tire to the hub has to be repeatedly assembled and disassembled. This means that threads on the bolts and on the nuts can get stripped or damaged faster than other vehicles. Besides, the fastening structure, when getting weather-beaten, can be rusty and embrittled, leading to risks of wheel detachment.

### SUMMARY OF THE INVENTION

The primary objective of the present invention is to satisfy the unmet need for accurate detection of correct fixation between a tire and a hub and to thereby prevent danger caused by unexpected detachment of vehicle wheels.

In order to achieve the foregoing objective, the present invention, in one embodiment, provides a wheel detachment monitoring and detection device, which is to be installed on a vehicle wheel using a fastening member that passes through a fastening hole formed on the vehicle wheel. The wheel detachment monitoring and detection device comprises a washer, a housing, a detachment detection module, and a power source. The washer comprises a through hole and an engaging portion, in which the through hole is for the fastening member to pass through and fix the washer, and the fastening member is sized to at least cover a part of the engaging portion. The housing comprises an upper housing piece and a lower housing piece, in which the upper housing piece has an upper extension portion and the lower housing piece has a lower extension portion, so that the upper extension portion and the lower extension portion are combined together to be engaged with the engaging portion. The detachment detection module has a pressure sensing portion located between the upper extension portion and the lower extension portion, in which the pressure sensing portion is pressed by the fastening member to press against a surface of the vehicle wheel and detects a pressing force acting thereon, so that when the pressure sensing portion detects disappearance of the pressing force, the detachment detection module sends out a warning signal. The power source is coupled to the detachment detection module to power the detachment detection module.

Thereby, the wheel detachment monitoring and detection device of the present invention can use the detachment detection module to accurately detect whether the fastening member is properly fastened, so as to monitor attachment of the vehicle wheel in a real-time manner and prevent unexpected detachment of the vehicle wheel.

### BRIEF DESCRIPTION OF THE DRAWINGS

FIG. 1 is a perspective view of a wheel detachment monitoring and detection device according to one embodiment of the present invention.

FIG. 2 is an exploded view of the wheel detachment monitoring and detection device according to the embodiment of the present invention.

FIG. 3 is a bottom exploded view of the wheel detachment monitoring and detection device according to the embodiment of the present invention.

FIG. 4 is an applied view of the wheel detachment monitoring and detection device according to the embodiment of the present invention, showing the position of the wheel detachment monitoring and detection device installed on a vehicle wheel.

FIG. 5 is another applied view of the wheel detachment monitoring and detection device according to the embodiment of the present invention, showing that a detection pole is in its tightness position.

FIG. 6 is a further applied view of the wheel detachment monitoring and detection device according to the embodiment of the present invention, showing that the detection pole is in its looseness position.

FIG. 7 is a structural block diagram of the wheel detachment monitoring and detection device according to the embodiment of the present invention.

### DETAILED DESCRIPTION OF THE INVENTION

The following preferred embodiments when read with the accompanying drawings are made to clearly exhibit the above-mentioned and other technical contents, features and effects of the present invention. Through the exposition by means of the specific embodiments, people would further understand the technical means and effects the present invention adopts to achieve the above-indicated objectives. However, the accompanying drawings are intended for reference and illustration, but not to limit the present invention and are not made to scale.

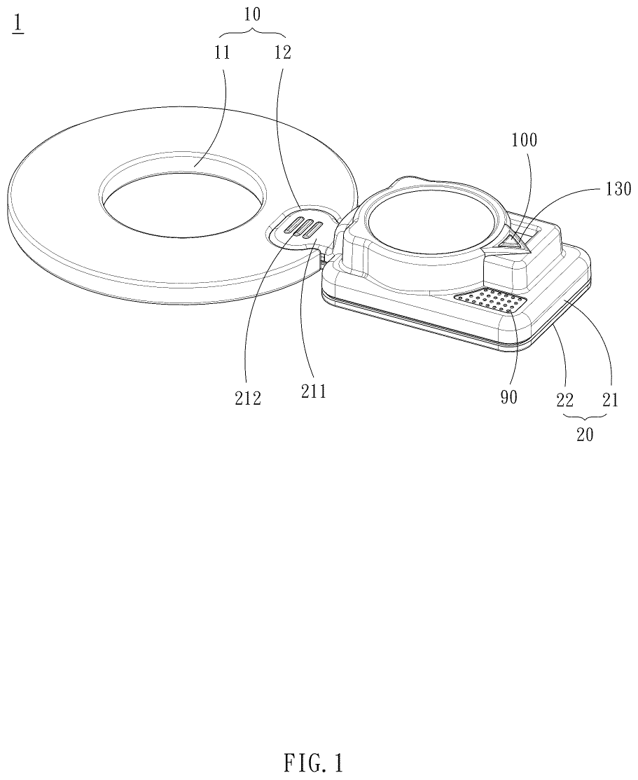

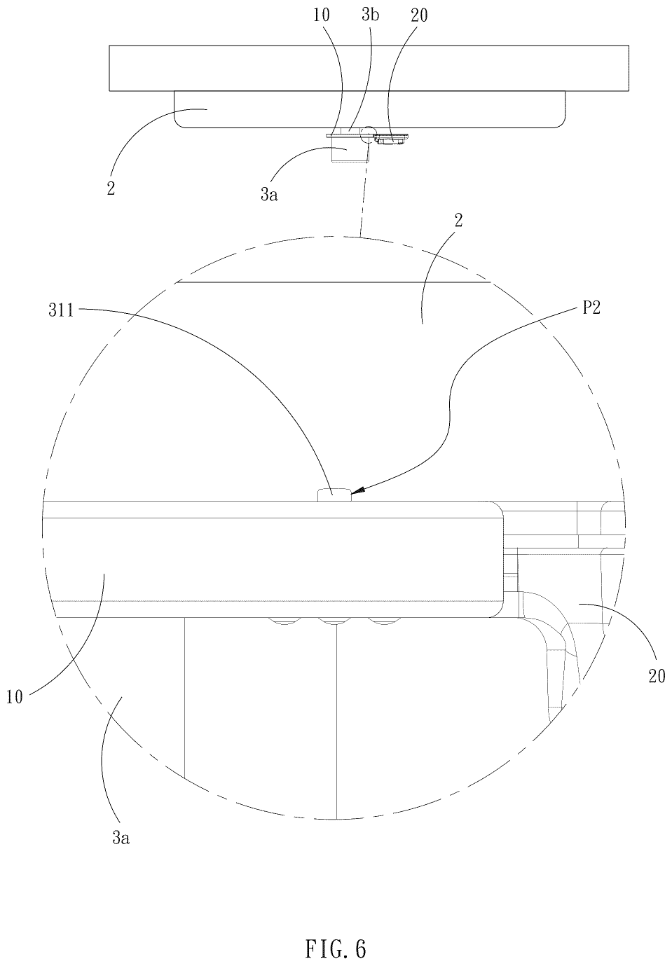

FIG. 1 through FIG. 7 depict a wheel detachment monitoring and detection device 1 according to one embodiment of the present invention. The wheel detachment monitoring and detection device 1 is designed to be installed on a vehicle wheel 2. The vehicle wheel 2 has a fastening hole 2a. The fastening hole 2a is for a fastening member 3 to pass therethrough and get fastened. The wheel detachment monitoring and detection device 1 comprises a washer 10, a housing 20, a detachment detection module 30, and a power source 40. The wheel detachment monitoring and detection device 1 further comprises a circuit board 50, a signal transmission antenna 60, a position module 70, a state control module 80, a trigger control module 90, a light emission module 100, a tire detection module 110, a temperature sensing module 120, and a pointing member 130. In the embodiment of the present invention, the wheel detachment monitoring and detection device 1 is to be installed on a spoke of the vehicle wheel 2.

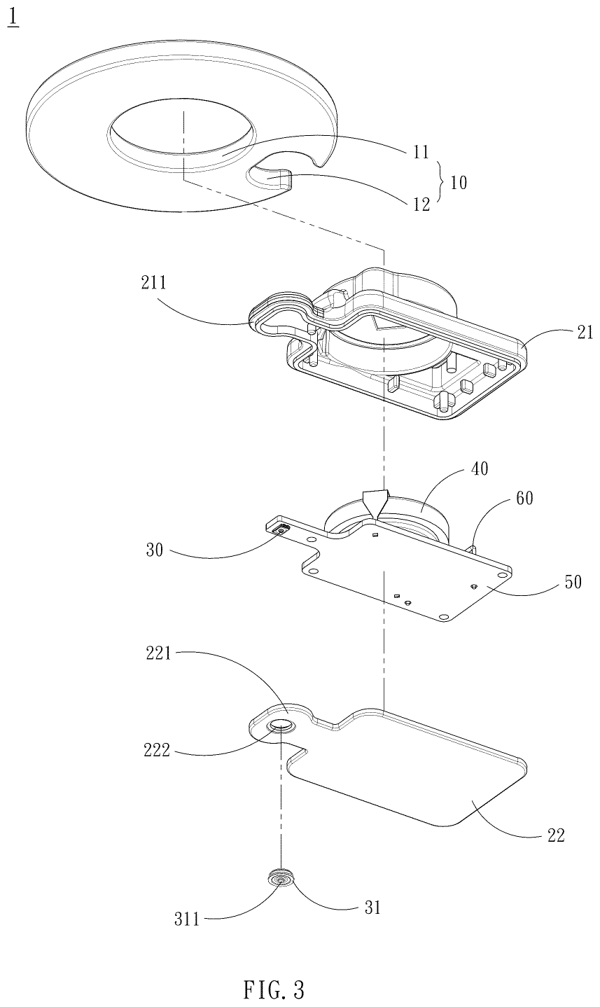

Referring to FIG. 3 through FIG. 6, the fastening member 3 comprises a nut 3a and a bolt 3b. The wheel detachment monitoring and detection device 1 is installed on the fastening structure between the tire and the hub, and is particularly located between the surface of the vehicle wheel 2 and the nut 3a. Generally, the nut 3a is threaded to be threadedly combined with the correspondingly threaded bolt 3b and thereby press against the surface of the vehicle wheel 2. Thus, once the nut 3a becomes loose after rotating in the unscrewing direction and starts to depart from the surface of the vehicle wheel 2, the vehicle wheel 2 is about to come off the hub. The device of present invention is configured to detect whether the nut 3a is effectively pressing against the surface of the vehicle wheel 2, or is departing from the surface of the vehicle wheel 2 due to ineffective combination, insufficient friction, or mechanical rustiness. Once the nut 3a becomes loose, the vehicle wheel 2 loses its attachment to the hub and can come off the hub anytime.

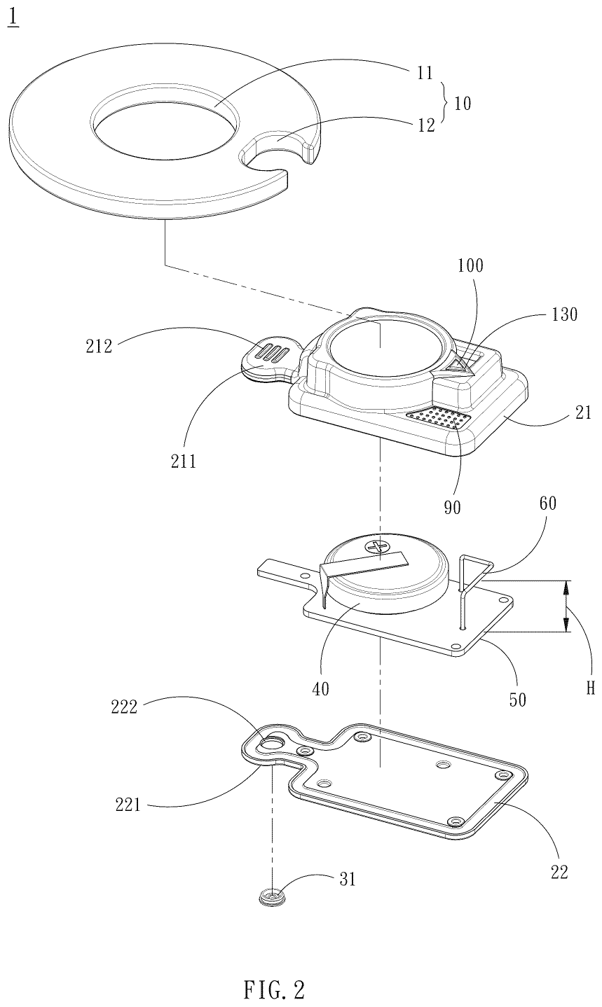

The washer 10 is formed with a through hole 11 and an engaging portion 12. The through hole 11 is for the fastening member 3 to pass therethrough and get fastened to the washer 10. The fastening member 3 is such sized that it at least covers a part of the engaging portion 12. Referring to FIG. 2 and FIG. 4 through FIG. 6, the washer 10 is affixed to the surface of the vehicle wheel 2 by the bolt 3b that passes through the through hole 11 and gets engaged with the nut 3a with their threads. After installation, the washer 10 is held in position between the nut 3a and the surface of the vehicle wheel 2. The engaging portion 12 is formed as a notch for receiving and retaining a part of the housing 20.

The housing 20 comprises an upper housing piece 21 and a lower housing piece 22. The upper housing piece 21 has an upper extension portion 211, and the lower housing piece 22 has a lower extension portion 221. The upper extension portion 211 and the lower extension portion 221 are designed to be combined with each other and get engaged with the engaging portion 12. Therein, the housing 20 defines therein a space for accommodating and protecting the detachment detection module 30 and the power source 40 from damage.

The disclosed device after installation is exposed outside the vehicle wheel 2 and subject to weather conditions, and therefore the housing 20 is preferably resistant to water and impact. Particularly, the housing 20 may achieve an ingress protection rating of IP64 or greater to effectively prevent rainwater or carwash water from ingress, and the housing 20 may have impact resistance of 1500g or more to protect against gravel or rocks flown by the rotating wheel, or against fault impact on the bolt during routine inspection. In the present embodiment, the housing 20 is made of a material that is free of metals so as not to cause interference with wireless communication signals.

As shown in FIG. 1 through FIG. 3, the upper extension portion 211 is provided with a plurality of bumps 212 at its surface. Provision of the bumps 212 is for increasing friction so as to better prevent the housing 20 from slipping with respect to the nut 3a. The lower housing piece 22 is further formed with a detection hole 222 that is located in the lower extension portion 221. The detection hole 222 is for the detachment detection module 30 to pass therethrough so that the detachment detection module 30 can detect the fastening state of the fastening member 3.

Herein, for better description of the embodiment of the present invention, the horizontal direction is defined as the direction parallel to the extending direction of the body of the washer 10, and the vertical direction is defined as the thickness direction of the washer 10. Referring to FIG. 1 through FIG. 3, the upper extension portion 211 has a changing width along the horizontal direction that is relatively large near the center of the washer 10 and relatively small remote from the center of the washer 10. The lower extension portion 221 is shaped to match the upper extension portion 211, and also has a changing width along the horizontal direction that is relatively large near the center of the washer 10 and relatively small remote from the center of the washer 10. Similarly, the engaging portion 12 has a changing width along the horizontal direction that is relatively large near the center of the washer 10 and relatively small remote from the center of the washer 10. In other words, the upper extension portion 211, the lower extension portion 221, and the engaging portion 12 each have a profile that includes a head (i.e., the wide part) and a neck (i.e., the narrow part). The structure can secure connection between the housing 20 and the washer 10 by effectively preventing the housing 20 from being thrown away from the washer 10 by the centrifugal force generated when the wheel is rotating. This is thus clear that any equivalent structure that has a narrowed part remote from the center of the washer 10 can be alternatively used to secure the connection between the housing 20 and the washer 10 against the centrifugal force. Such alternative structures of the upper extension portion 211, the lower extension portion 221, and the engaging portion 12 may include a triangular structure, a T-shaped structure, and any structure that has a wide head near the center of the washer 10 and a narrow neck remote from the center of the washer 10. Moreover, the washer 10 and the housing 20 may alternatively be made as an integral so as to eliminate problems about insecure connection between components of different materials.

The detachment detection module 30 has a pressure sensing portion 31 located between the upper extension portion 211 and the lower extension portion 221. The pressure sensing portion 31 is pressed against the surface of the vehicle wheel 2 by the fastening member 3 and serves to detect a pressing force normally applied. When detecting disappearance of the pressing force, the detachment detection module 30 sends out a warning signal to warn a user of looseness of the fastening member 3. In the present embodiment, the detachment detection module 30 may be an electronic device that sensitively detects existence of a physical gap and sends out an electronic signal correspondingly.

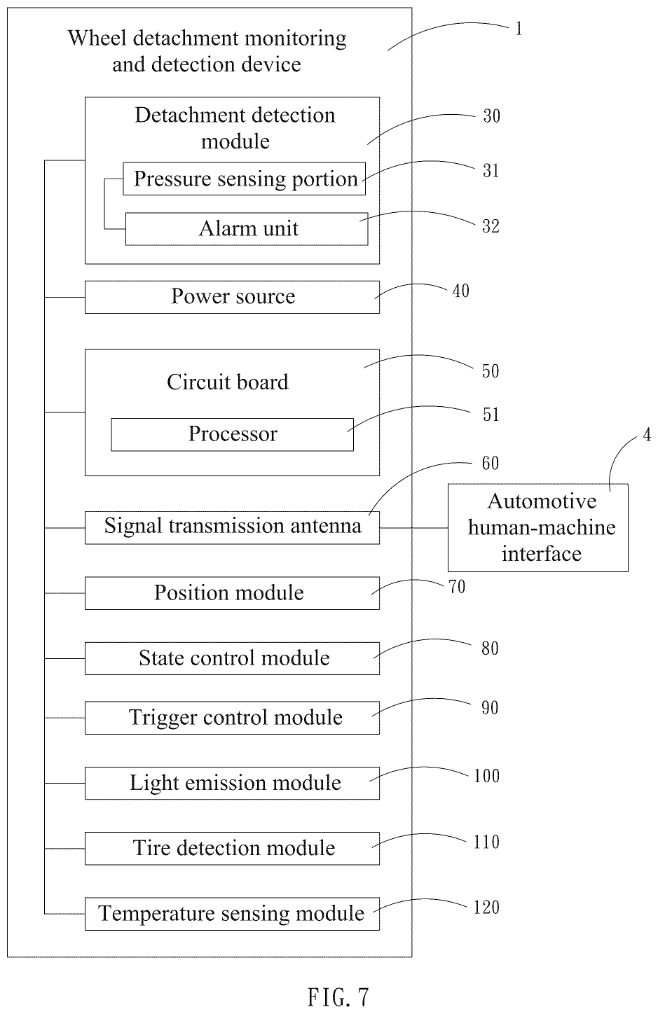

Referring to FIG. 7, in the embodiment of the present invention, the detachment detection module 30 further has an alarm unit 32. The alarm unit 32 is coupled to the pressure sensing portion 31. When the pressure sensing portion 31 detects disappearance of the pressing force, the alarm unit 32 gives the warning signal.

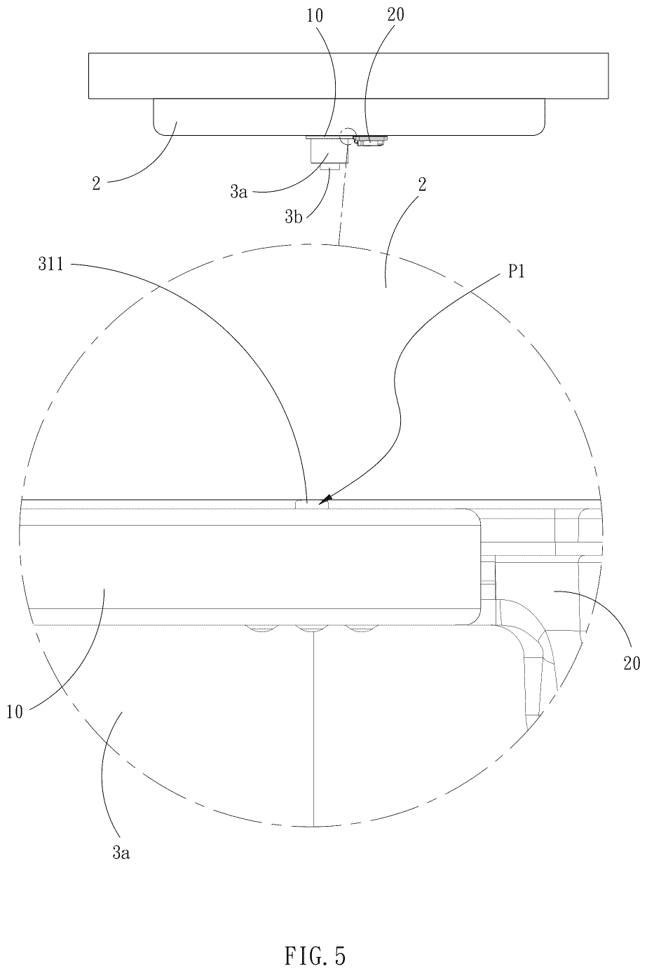

Referring to FIG. 3, and FIG. 5 through FIG. 7, in the embodiment of the present invention, the pressure sensing portion 31 further comprises a detection pole 311 that is located in the detection hole 222. The detection pole 311 can stretch out from the detection hole 222 to contact the surface of the vehicle wheel 2. Depending on that the fastening member 3 is relatively near or remote from the vehicle wheel 2, the detection pole 311 is in a tightness position P1 or a looseness position P2. When detection pole 311 is in the looseness position P2, the pressure sensing portion 31 sends out a looseness signal to the alarm unit 32 so that the alarm unit 32 gives the warning signal in response.

Referring to FIG. 3 and FIG. 5 through FIG. 7, in another embodiment of the present invention, when the detection pole 311 is in the tightness position P1, the pressure sensing portion 31 continuously sends out a tightness signal to the alarm unit 32. When the detection pole 311 is in the looseness position P2, the pressure sensing portion 31 stops sending out the tightness signal to the alarm unit 32. The alarm unit 32, when not receiving the tightness signal, sends out the warning signal. Therein, the alarm unit 32 may be such programmed that it does not send out the warning signal until expiration of a waiting period after the pressure sensing portion 31 stops sending out the tightness signal. This is for minimizing false positives caused by errors about signal receipt at the alarm unit 32. The detachment detection module 30 may be programmed with a signal-sending interval, so that the pressure sensing portion 31 sends out the tightness signal regularly according to the signal-sending interval. This helps reduce power consumption of the detachment detection module 30 and maximize battery life. The signal-sending interval may be set to be once per minute, once every two minutes, once every three minutes, or the like.

Thereby, by starting to send out the looseness signal or stopping sending out the tightness signal when the detection pole 311 comes to the looseness position P2, the pressure sensing portion 31 can accurately report the fastening state of the fastening member 3.

It is also to be noted that the detachment detection module 30, instead of being located between the nut 3a and the surface of the vehicle wheel 2, may be arranged alternatively. To be specific, if the nut 3a and/or the vehicle wheel 2 do not have planar area large enough to hold the detachment detection module 30, an auxiliary plate may be provided at the side of the nut 3a facing the detachment detection module 30, or at the side of the vehicle wheel 2 facing the detachment detection module 30, or at each the side of the nut 3a and the side of the vehicle wheel 2 facing the detachment detection module 30, so as to furnish sufficient planar area for holding the detachment detection module 30 in position.

The power source 40, in one embodiment, is coupled to and power the detachment detection module 30, the circuit board 50, the signal transmission antenna 60, the position module 70, the state control module 80, the trigger control module 90, the light emission module 100, the tire detection module 110, and the temperature sensing module 120. In the present embodiment, the power source 40 is a button cell battery that is compact and powerful enough to power the whole device and has advantages relating to high stability and long service life.

The circuit board 50 is installed in the housing 20, and in one embodiment it has a processor 51. The processor 51 is coupled to the detachment detection module 30. The processor 51 receives and transmits the warning signal. In the present embodiment, the circuit board 50 may be a PCB or another substrate for electronic use, and serves to carry the detachment detection module 30, the power source 40, and other electronic components. The circuit board 50 is installed with necessary functional chips, a touch chip, an oscillator, and the processor 51 for signal integration among electronic components.

The signal transmission antenna 60 may be installed on the circuit board 50 and coupled to the processor 51 and an automotive human-machine interface 4. The signal transmission antenna 60 transmits the warning signal to the automotive human-machine interface 4. The automotive human-machine interface 4, when receiving the warning signal, sends out a detachment message to inform the user of looseness of the fastening member 3. Therein, the signal transmission antenna 60 is raised from the top surface of the circuit board 50 for an installation height H. The installation height H is of between 0.2 cm and 2 cm. Preferably, the installation height H is of between 0.5 cm and 2 cm, so as to reduce instable transmission.

In the present embodiment, the circuit board 50 is located close to the metal-made wheel rim. For preventing electromagnetic signals sent to or from the signal transmission antenna 60 from being instable or lost due to the shielding effect of metal, the signal transmission antenna 60 is preferably a monopole antenna. The signal transmission antenna 60 may have a frequency of 2.4 GHz, 315 MHz, or 433 MHZ. Preferably, signals from the disclosed wheel detachment monitoring and detection device 1 and signals from a tire-pressure monitoring system may be received together by the automotive human-machine interface 4. To this end, the frequency of the wheel detachment monitoring and detection device 1 may be selected accordingly, and may be the same as or different from that of the tire-pressure monitoring system.

In one embodiment, the position module 70 is installed in the housing 20 and coupled to the processor 51. The position module 70 serves to record a position information of the wheel detachment monitoring and detection devices 1 on different vehicle wheels 2 and send the position information to the automotive human-machine interface 4 through the processor 51 for the user to check. For example, the position information may indicate that the wheel detachment monitoring and detection devices 1 numbered #1 and #2 are installed on the left front wheel; the wheel detachment monitoring and detection devices 1 numbered #3 and #4 are installed on the right front wheel; the wheel detachment monitoring and detection devices 1 numbered #5 and #6 are installed on the left rear wheel; the wheel detachment monitoring and detection devices 1 numbered #7 and #8 are installed on the right rear wheel of a car. Thereby, the user can tell a given alarm is associated with which vehicle wheel 2 through the automotive human-machine interface 4.

The state control module 80 in one embodiment is installed in the housing 20 and coupled to the processor 51. The state control module 80 serves to control the wheel detachment monitoring and detection device 1 to switch among an off state, a detection state, and a sleep state. The state control module 80 may be a multi-step switch for controlling the wheel detachment monitoring and detection device 1 to be in the off state, the detection state, or the sleep state.

The trigger control module 90 in one embodiment is installed on the upper housing piece 21 and coupled to the processor 51 and the state control module 80. The user can operate the trigger control module 90 to output a trigger signal to the processor 51. The state control module 80 is thereby triggered to control the wheel detachment monitoring and detection device 1 to be in the off state, the detection state, or the sleep state. In the present embodiment, the trigger control module 90 is a capacitive trigger, so that the user can give different instructions by placing his/her finger on the housing 20 corresponding to the trigger control module 90 and performing touch in different patterns to instruct the processor 51 to conduct different works. For example, the touch patterns may include long touch for 1 second, 3 seconds, or 10 seconds, or short touch composed of 1 push, 2 pushes, or 3 pushes.

The light emission module 100 is installed on the upper housing piece 21 and coupled to the processor 51 and the state control module 80. The light emission module 100 emits light in different patterns depending on whether the wheel detachment monitoring and detection device 1 is in the off state, the detection state, or the sleep state, so as to inform the user of the current operational state of the wheel detachment monitoring and detection device 1. For example, constant light indicates that the wheel detachment monitoring and detection device 1 is in the detection state and flashing light indicates that the wheel detachment monitoring and detection device 1 is in the sleep state.

The tire detection module 110 in one embodiment is installed in the housing 20 and coupled to the processor 51 and the state control module 80. The tire detection module 110 detects rotation of the vehicle wheel 2 and outputs a tire rotation signal or a tire stop signal correspondingly. When the tire detection module 110 outputs the tire rotation signal, the state control module 80 receives the tire rotation signal and controls the wheel detachment monitoring and detection device 1 to be in the detection state. When the tire detection module 110 outputs the tire stop signal, the state control module 80 receives the tire stop signal and controls the wheel detachment monitoring and detection device 1 to be in the sleep state.

The temperature sensing module 120 in one embodiment is installed in the housing 20 and coupled to the processor 51. The temperature sensing module 120 measures the temperature of the vehicle wheel 2. When the temperature of the vehicle wheel 2 is higher than a temperature threshold, the temperature sensing module 120 outputs a temperature warning signal to the processor 51. Thereby, when the temperature sensing module 120 determines that the temperature of the vehicle wheel 2 is excessively high, it sends out the temperature warning signal to the processor 51, and the processor 51 transmits the temperature warning signal to the automotive human-machine interface 4 in the car through the signal transmission antenna 60 to inform the user of this. Therein, fair temperature measuring capability is enough for the temperature sensing module 120 to monitor the temperature of the vehicle wheel 2 for the purpose of the present invention. Thus, the temperature sensing module 120 may be installed in the housing 20 and measure the temperature of the vehicle wheel 2 conducted to it by the housing 20. The actual temperature of the vehicle wheel 2 can then be determined by means of temperature compensation. Alternatively, a metal sheet may be inserted through the housing 20 so that it contacts the temperature sensing module 120 and the vehicle wheel 2 at two ends thereof. With the good thermal conductivity of the metal sheet, the temperature sensing module 120 can rapidly and accurately measure the temperature of the vehicle wheel 2.

The pointing member 130 in one embodiment is provided on the upper housing piece 21. When the fastening member 3 is fastened, the pointing member 130 is aligned with a mark 2b formed on the vehicle wheel 2. In the present embodiment, the fastening member 3 is two or more in number, and the wheel detachment monitoring and detection device 1 is also two or more in number. When the fastening members 3 are both/all fastened, the pointing members 130 of two adjacent wheel detachment monitoring and detection devices 1 are aligned with each other. Thus, with the car being off or stopped, the user or the driver of the car can be aware of looseness of the fastening member 3 when seeing that the two adjacent pointing members 130 are not aligned with each other.

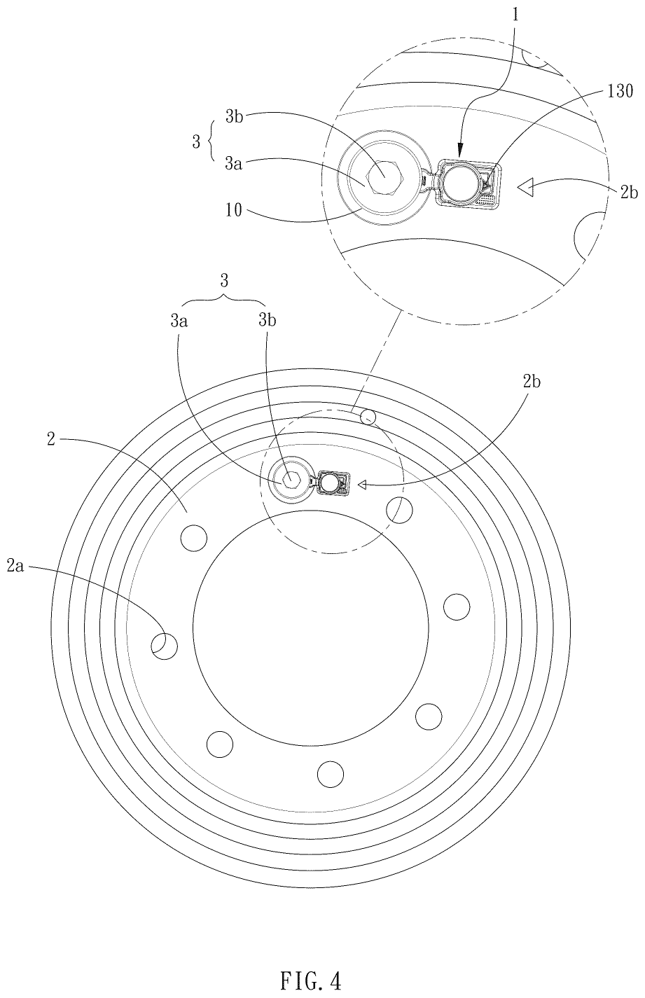

As shown in FIG. 4, in the embodiment of the present invention, the pointing member 130 may be formed as an arrow mark for easy visual recognition. The user, in the process of rotating the nut 3a toward the bolt 3b to press against the surface of the vehicle wheel 2, adjusts the position of the pointing member 130 to align it with the mark 2b, and ensures that the pointing member 130 is aligned with the mark 2b after the bolt 3b and the nut 3a are threadedly combined. Thereby, if the nut 3a becomes loose, the user can easily notice this when seeing the offset between the pointing member 130 and the mark 2b. Alternatively, two wheel detachment monitoring and detection devices 1 of the present invention may be installed on two adjacent bolts 3b of the same vehicle wheel 2 so that the two pointing members 130 are aligned with each other. With this arrangement, once the pointing members 130 move with respect to each other to the extent that the two pointing members 130 become offset against each other, it indicates that one or both of the nuts 3a becomes loosen or displaced, so as to provide indication equivalently.

Use of the wheel detachment monitoring and detection device 1 will be detailed below.

After the washer 10 connected with the detachment detection module 30 is installed between the nut 3a and the surface of the vehicle wheel 2 and the nut 3a is firmly combined with the bolt 3b, a user can start the wheel detachment monitoring and detection device 1 by touching and holding the trigger control module 90 for a period of time (such as 3 seconds or 10 seconds). This in turn activates the processor 51, the detachment detection module 30, and other electronic components. Therein, the light emission module 100 emits light at the same time to inform the user of the start-up. Meanwhile, the detachment detection module 30 is pressed between the nut 3a and the surface of the vehicle wheel 2 and triggers a normal operation signal to the processor 51. The processor 51 may send the normal operation signal to the automotive human-machine interface 4 in the car through the signal transmission antenna 60 at a predetermined interval to inform the driver in the car that attachment of the vehicle wheel 2 is sound. In order to reduce power consumption, the interval for sending the normal operation signal to the automotive human-machine interface 4 may be once per minute, once every two minutes, once every three minutes, or the like.

During work of the wheel detachment monitoring and detection device 1, if the nut 3a departs from its initial position with respect to the surface of the vehicle wheel 2 due to looseness, rotation, or damage, even for a very small departure, the detachment detection module 30 can detect the departure and sends the looseness signal or stops sending the tightness signal to the alarm unit 32. After receiving the looseness signal or stopping receiving the tightness signal for a predetermined period of time (such as 1 second, 5 seconds, 30 seconds, or 2 minutes), the alarm unit 32 outputs the warning signal to the processor 51, and the processor 51 sends the warning signal to the automotive human-machine interface 4 in the car through the signal transmission antenna 60. As a result, the automotive human-machine interface 4 sounds, vibrates, or emits light to inform the driver that detachment of the vehicle wheel 2 occurs and the car has to be stopped for inspection.

It is to be noted that as long as the detachment detection module 30 is able to inform the processor 51 of that the nut 3a is fastened firmly and that the nut 3a becomes loose in different ways, it satisfies the technical needs of the present invention, so the determination does not necessarily depend on whether there is a signal transmitted or not.

The automotive human-machine interface 4 is installed in the car and communicates with a communication device of the user through wireless transmission. The communication device refers to a communication device or a tablet computer equipped with a Bluetooth communication interface. The user can use the communication device to connect the automotive human-machine interface 4, so that the automotive human-machine interface 4 can automatically upload detection information. The automotive human-machine interface 4 uses a short-range wireless communication module as a medium to transmit and receive information to and from the communication device, and the communication device uses a long-range wireless communication module as a medium to transmit and receive information to and from a cloud-based management system.

Therein, the automotive human-machine interface 4 is an on-board computer, an external drive, a tablet computer, or a handheld communication device, and it may comprise a short-range communication interface. The detachment detection module 30 is connected to the automotive human-machine interface 4 through the signal transmission antenna 60, and it works with an on-board diagnostics system or is connected to the controller area network bus of the car to provide information about possible causes of looseness, such as human mistakes or component ageing. The short-range wireless communication module herein is a Bluetooth communication interface. The long-range wireless communication module herein includes General Packet Radio Service (GPRS), cellular network, and mm Wave.

In the present embodiment, for example, when the detachment detection module 30 is not pressed by any external force and not performing detection, the user operate the trigger control module 90 to generate a trigger (by, for example, touching and holding the trigger control module 90 for a predetermined period of time) to output the trigger signal to the processor 51, thereby making the state control module 80 enter the wheel detachment monitoring and detection device 1 into the sleep state or directly into the off state. If at this time the detachment detection module 30 is actually pressed by an external force and performing detection, the processor 51 can determine that this is a false trigger and the state control module 80 makes the wheel detachment monitoring and detection device 1 stay in the detection state.

Moreover, the state control module 80 can control the wheel detachment monitoring and detection device 1 to enter the detection state automatically. For example, after the pressure sensing portion 31 detects the pressing force and a period of time (such as 10 seconds) lapses, the state control module 80 automatically enters the wheel detachment monitoring and detection device 1 into the detection state from the sleep state or the off state. Meanwhile, the light emission module 100 emits flashing light for 1 through 3 seconds to inform the user that the wheel detachment monitoring and detection device 1 has entered the detection state.

The state control module 80 may alternatively make the wheel detachment monitoring and detection device 1 enter the sleep state automatically. For example, when the wheel detachment monitoring and detection device 1 detects that the tire has stayed still for a predetermined period of time without any movement, it enters the sleep state automatically, and when the tire moves again, it detection state automatically.

Of course, position information of the wheel detachment monitoring and detection devices 1 with respect to the vehicle wheels 2 of a car may be pre-loaded into the automotive human-machine interface 4 through the position module 70. For example, Devices #1 and #2 are installed on the left front wheel; Devices #3 and #4 are installed on the right front wheel; Devices #5 and #6 are installed on the left rear wheel; and Devices #7 and #8 are installed on the right rear wheel. Thereby, the automotive human-machine interface 4 can refer to the source of the signal to tell the current alarm is associated to which vehicle wheel 2.

Particularly, since the wheel detachment monitoring and detection device 1 is installed on the surface of the vehicle wheel 2, the user can easily touch the trigger control module 90 to make the position module 70 of the wheel detachment monitoring and detection device 1 send out the position information to the automotive human-machine interface 4 to see on which vehicle wheel 2 the wheel detachment monitoring and detection device 1 is installed. For example, the user may enter a setting page through the automotive human-machine interface 4 in which page the user can set the position of a wheel detachment monitoring and detection device 1 and the corresponding vehicle wheel 2. In the setting page, the user can operate the automotive human-machine interface 4 to start “Left Front Wheel” setting, and, in this setting mode, touch the trigger control module 90 to trigger the given wheel detachment monitoring and detection device 1 to send out the position information to the automotive human-machine interface 4. Thereby, the automotive human-machine interface 4 reports that the given wheel detachment monitoring and detection device 1 is installed in the left front wheel. Similarly, wheel detachment monitoring and detection devices 1 on the other vehicle wheels 2 may be set one by one, so as to associate the vehicle wheels 2 with the respective wheel detachment monitoring and detection devices 1.

It is also to be noted that one vehicle wheel 2 may have plural sets of bolts 3b and nuts 3a. Therefore, plural wheel detachment monitoring and detection devices 1 of the present invention may be installed on the same vehicle wheel 2 to monitor the plural nuts 3a. However, in view that detachment of a vehicle wheel 2 can only happen when most of the nuts 3a on the vehicle wheel 2 become loose, it is unnecessary to have each and every combination of the bolt 3b and nut 3a on a vehicle wheel 2 monitored with a wheel detachment monitoring and detection device 1 of the present invention.

To sum up, the present invention has the following advantages:
1. With the detachment detection module 30, the wheel detachment monitoring and detection device 1 can accurately determine whether the fastening member 3 is properly fastened, so as to achieve real-time detection of attachment of the vehicle wheel 2 and prevent unexpected detachment of the vehicle wheel 2;
2. With the signal transmission antenna 60, the wheel detachment monitoring and detection device 1 can be integrated with the automotive human-machine interface 4 so as to provide the driver of the car with real-time information about attachment of the vehicle wheels 2 through the automotive human-machine interface 4;
3. The special profile of the upper extension portion 211, the lower extension portion 221, and the engaging portion 12 effectively prevents the housing 20 from being thrown away from the washer 10, thereby ensuring firm connection between the washer 10 and the housing 20;
4. The position module 70 accurately records the position information of each wheel detachment monitoring and detection device 1 and sends the information to the automotive human-machine interface 4, so that the driver can be aware of to which vehicle wheel 2 the current alarm is associated by referring to the automotive human-machine interface 4;
5. The state control module 80 and the trigger control module 90 allow the user to control operation of the wheel detachment monitoring and detection device 1 easily and conveniently, and the light emission module 100 informs the user of the real-time operation state of the wheel detachment monitoring and detection device 1 visually; and
6. With the cooperation of the pointing member 130 and the mark 2b, the user can be informed of whether the fastening member 3 become loose in an intuitive manner.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A wheel detachment monitoring and detection device, which is to be installed on a vehicle wheel using a fastening member that passes through a fastening hole formed on the vehicle wheel, the wheel detachment monitoring and detection device comprising:
a washer, defining a through hole and having an engaging portion, in which the through hole is for the fastening member to pass through and fix the washer, and the fastening member is sized to at least cover a part of the engaging portion;
a housing, comprising an upper housing piece and a lower housing piece, in which the upper housing piece has an upper extension portion and the lower housing piece has a lower extension portion, so that the upper extension portion and the lower extension portion are combined together to be engaged with the engaging portion;
a detachment detection module, having a pressure sensing portion located between the upper extension portion and the lower extension portion, in which the pressure sensing portion is pressed by the fastening member to press against a surface of the vehicle wheel and detects a pressing force acting thereon, so that when the pressure sensing portion detects disappearance of the pressing force, the detachment detection module sends out a warning signal; and
a power source, being coupled to and powering the detachment detection module.

2. The wheel detachment monitoring and detection device of claim 1, wherein the upper extension portion has a surface provided with a plurality of bumps.

3. The wheel detachment monitoring and detection device of claim 1, wherein the upper extension portion has a changing width that is relatively large near a center of the washer and is relatively small remote from the center of the washer, and the lower extension portion also has a changing width that is relatively large near the center of the washer and is relatively small remote from the center of the washer.

4. The wheel detachment monitoring and detection device of claim 1, wherein the detachment detection module further has an alarm unit, in which the alarm unit is coupled to the pressure sensing portion, so that when the pressure sensing portion detects disappearance of the pressing force, the alarm unit sends out the warning signal.

5. The wheel detachment monitoring and detection device of claim 4, wherein the lower housing piece further defines a detection hole located in the lower extension portion, and the pressure sensing portion further comprises a detection pole that is installed in the detection hole and configured to stretch out of the detection hole to contact the surface of the vehicle wheel, in which depending on that the fastening member is relatively near or remote from the vehicle wheel, the detection pole is in a tightness position or a looseness position, and when the detection pole is in the looseness position, the pressure sensing portion sends out a looseness signal to the alarm unit so that the alarm unit sends out the warning signal in response.

6. The wheel detachment monitoring and detection device of claim 4, wherein the lower housing piece further defines a detection hole located in the lower extension portion, and the pressure sensing portion further comprises a detection pole that is installed in the detection hole and configured to stretch out of the detection hole to contact the surface of the vehicle wheel, in which depending on that the fastening member is relatively near or remote from the vehicle wheel, the detection pole is in a tightness position or a looseness position, and when the detection pole is in the tightness position, the pressure sensing portion keeps sending a tightness signal to the alarm unit, and when the detection pole is in the looseness position, the pressure sensing portion stops sending the tightness signal to the alarm unit, so that the alarm unit sends out the warning signal correspondingly.

7. The wheel detachment monitoring and detection device of claim 6, wherein after the pressure sensing portion stops sending the tightness signal for a waiting period, the alarm unit sends out the warning signal correspondingly.

8. The wheel detachment monitoring and detection device of claim 6, wherein the detachment detection module is programmed with a signal-sending interval so that the pressure sensing portion sends out the tightness signal regularly according to the signal-sending interval.

9. The wheel detachment monitoring and detection device of claim 1, further comprising a circuit board, which is installed in the housing and has a processor, wherein the processor is coupled to the detachment detection module and serves to receive and transmit the warning signal.

10. The wheel detachment monitoring and detection device of claim 9, further comprising a signal transmission antenna, which is installed on the circuit board and coupled to the processor, wherein the signal transmission antenna serves to transmit the warning signal.

11. The wheel detachment monitoring and detection device of claim 10, wherein the signal transmission antenna is raised from a top surface of the circuit board for an installation height that is of between 0.2 cm and 2 cm.

12. The wheel detachment monitoring and detection device of claim 10, wherein the signal transmission antenna is coupled to an automotive human-machine interface, in which the automotive human-machine interface receives the warning signal and sends out a detachment message to a user accordingly.

13. The wheel detachment monitoring and detection device of claim 9, further comprising a position module, which is installed in the housing and coupled to the processor, wherein the position module records a position information about the wheel detachment monitoring and detection device and the vehicle wheel on which the wheel detachment monitoring and detection device is installed.

14. The wheel detachment monitoring and detection device of claim 9, further comprising a state control module, which is installed in the housing and coupled to the processor, wherein the state control module serves to control the wheel detachment monitoring and detection device to be in an off state, a detection state, or a sleep state.

15. The wheel detachment monitoring and detection device of claim 14, further comprising a trigger control module, which is installed on the upper housing piece and coupled to the processor and the state control module, wherein the trigger control module when operated by a user outputs a trigger signal to the processor to trigger the state control module to control the wheel detachment monitoring and detection device to be in the off state, the detection state, or the sleep state.

16. The wheel detachment monitoring and detection device of claim 14, further comprising a light emission module, which is installed on the upper housing piece and coupled to the processor and the state control module, wherein the light emission module emits light in different patterns depending on that the wheel detachment monitoring and detection device is in the off state, the detection state, or the sleep state.

17. The wheel detachment monitoring and detection device of claim 14, further comprising a tire detection module, which is installed in the housing and coupled to the processor and the state control module, wherein the tire detection module serves to detect rotation of the vehicle wheel and output a tire rotation signal or a tire stop signal accordingly, in which when the tire detection module outputs the tire rotation signal, the state control module receives the tire rotation signal and controls the wheel detachment monitoring and detection device to be in the detection state, and when the tire detection module outputs the tire stop signal, the state control module receives the tire stop signal and controls the wheel detachment monitoring and detection device to be in the sleep state.

18. The wheel detachment monitoring and detection device of claim 9, further comprising a temperature sensing module, which is installed in the housing and coupled to the processor, wherein the temperature sensing module serves to measure a temperature of the vehicle wheel, and when the temperature of the vehicle wheel is higher than a predetermined temperature threshold, the temperature sensing module outputs a temperature warning signal to the processor.

19. The wheel detachment monitoring and detection device of claim 1, further comprising a pointing member, which is installed on the upper housing piece, wherein when the fastening member is fastened, the pointing member is aligned with a mark formed on the vehicle wheel.

20. The wheel detachment monitoring and detection device of claim 19, wherein the fastening member is two or more in number, and the wheel detachment monitoring and detection device is also two or more in number, in which when the fastening members are all fastened, the pointing members of two adjacent said wheel detachment monitoring and detection devices are aligned with each other.
